(19) United States
(12) Patent Application Publication
(10) Pub. No.: US 2009/0274337 A1
(43) Pub. Date: Nov. 5, 2009

(54) SPEAKER VOICE COIL

(75) Inventors: Yoshihide Goto, Yamagata (JP); Taiki Goto, Yamagata (JP); Naoto Takahashi, Yamagata (JP)

Correspondence Address: KRATZ, QUINTOS & HANSON, LLP, 1420 K Street, N.W., Suite 400, WASHINGTON, DC, 20005, US

(73) Assignee: GOTO ELECTRONIC CO., LTD., Sagae-shi (JP)

(21) Appl. No.: 12/180,734

(22) Filed: Jul. 28, 2008

(30) Foreign Application Priority Data
Apr. 30, 2008 (JP) 2008-118313

(51) Int. Cl. H04R 1/00

(52) U.S. Cl. 381/409

(57) ABSTRACT

The present invention is to provide a speaker voice coil having an improved productivity, a lightweight, a good response to vibration, and an elimination of a specified frequency. The speaker voice coil includes a plurality of coil main bodies connected in series each other, the coil main bodies each have a lead-in wire portion and a lead-out wire portion at a periphery of an end of the respective coil main bodies, the lead-in wire portion of one coil main body continuously communicating with the lead-out wire portion of the adjacent coil main body.

### BACKGROUND OF THE INVENTION

1. Field of the Invention

The present invention relates to a speaker voice coil having an improved productivity, a lightweight, a suppression of deterioration of sound pressure level and a biased weight of a diaphragm, a high reproducibility of vibration, and a protection of resonance of a certain frequency.

2. Description of the Related Art

A conventional speaker has a pair of voice coils connected in series in a magnetic circuit to achieve a small size and a lightweight. The voice coils are anti-phase and arranged in a magnetic gap of the magnetic circuit to drive a diaphragm larger than twice as the voice coils. The two voice coils are connected to one another with soldering between a lead-in wire portion of one voice coil and a lead-out wire portion of another voice coil (for example, JP 2006-246288). The soldering between the lead-in and lead-out wire of the respective voice coils requires an additional step, resulting in increase of manufacturing process and cost.

The soldering increases weight of the voice coils. The serial arrangement of the voice coils having the soldered connection portion reduces response of the voice coils to a diaphragm, resulting in damage or breaking of the voice coils and short life duration.

The increase of weight of the voice coils results in reduction of sound pressure level of the speaker, rolling of the diaphragm, and inhomogeneous vibration, and further causes a resonance of a certain frequency to impair a correct playback of the voice coils.

### SUMMARY OF THE INVENTION

An object of the present invention is to provide a speaker voice coil connected in series without soldering. The speaker voice coil has a lightweight, a superior response to a diaphragm, and a long mechanical life without a reduction of a sound pressure level, a biased weight, an inhomogeneous amplitude, a resonance of the diaphragm with a specific frequency. The speaker voice coil of the present invention is manufactured with low cost.

According to a first aspect of the present invention, a speaker voice coil includes a plurality of coil main bodies connected to each other in series, the coil main bodies each being formed by winding a wire with a desired diameter and having a lead-in wire portion and a lead-out wire portion at a periphery of one end thereof, the lead-out wire portion of one coil main body being continuously communicated with the lead-in wire portion of an adjacent coil main body.

Preferably, the lead-in wire portion and the lead-out wire portion of the associated coil main body are integral at the periphery of the end of the coil main body and the wire is covered with an insulation.

Preferably, the coil main bodies are disposed in a two-dimensional array.

Preferably, the coil main bodies are formed in a plurality of layers.

Preferably, the coil main bodies each are wound with the wire by a desired number of turns.

Preferably, the coil main bodies each are wound with the wire by the respective numbers of turns.

Preferably, the coil main bodies each are bonded together to each other with an adhesive agent applied between adjacent side faces thereof.

Preferably, the lead-in portion and the lead-out wire portion form a sag portion with a desired length.

Preferably, the sag portions are attached to a voice coil bobbin.

Preferably, the plurality of the coil main bodies are capable of vibrating a diaphragm having a length and a width at least twice as the coil main bodies.

Preferably, the wire has a section of circle, ellipse, square, flat, or rectangle.

### BRIEF DESCRIPTION OF THE DRAWINGS

FIG. 1 is a perspective view of a first embodiment of the speaker voice coil of the present invention;

FIG. 2 is a perspective view of a plurality of dispersed coil main bodies; and

FIG. 3 is a perspective view of a second embodiment of the speaker voice coil of the present invention.

### DETAILED DESCRIPTION OF THE PREFERRED EMBODIMENTS

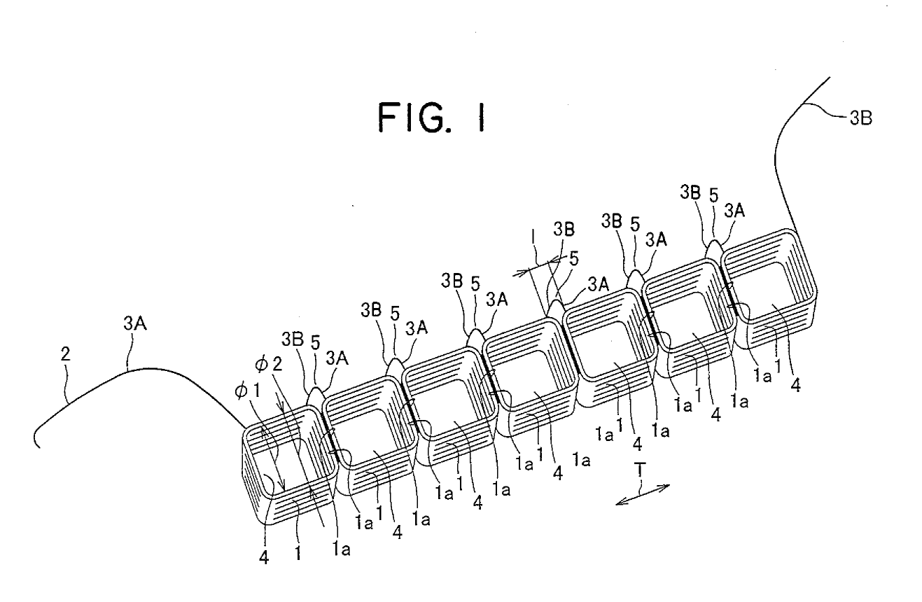

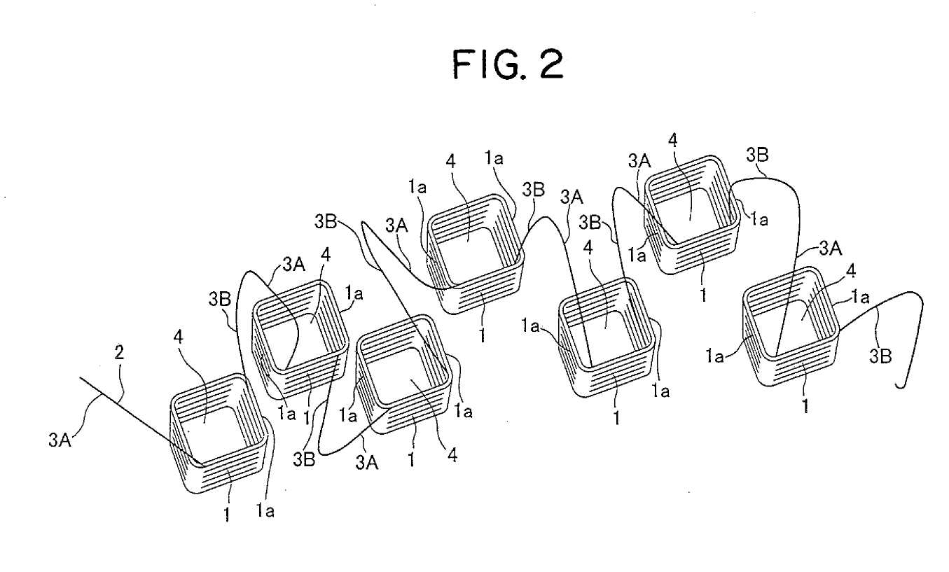

FIG. 1 is a perspective view of a first embodiment of a speaker voice coil of the present invention and FIG. 2 is a perspective view of a plurality of the voice coils separated each other.

The speaker voice coil includes a plurality of coil main bodies 1 each formed with spiral-winding of wire 2 of a desired diameter and having a lead-in wire portion 3A and a lead-out wire portion 3B integrally disposed on one end of the respective coil main bodies 1, the coil main bodies 1 being continuously connected in series together with the lead-in and lead-out wire portions 3A and 3B. The lead-out wire portion 3B of one coil main body 1 is continuously connected to the lead-in wire portion 3A of an adjacent coil main body 1.

The coil main bodies 1 each is formed in a rectangle shape with a hollow portion 4 of an inner width of 8.5 mm prepared with a covered copper wire with a circle section of diameter of 0.12 mm with 38 turns of alpha winding. The first embodiment of the speaker voice coil has two layers of seven coil main bodies 1 connected in a direction T. The lead-in and lead-out wire portions 3A and 3B are each integrally disposed at a periphery of the end of the coil main body 1.

When the coil main bodies are piled up in an axial direction thereof, the lead-out wire portion 3B of an upper coil main body 1 continuously communicates with the lead-in wire portion 3A of a lower coil main body 1 without soldering.

The coil main bodies 1 are bonded each other with an adhesive agent to make side faces la contact together. The coil main bodies 1 bonded with the adhesive agent increases rigidity, resulting in a homogeneous vibration of the diaphragm, or improvement of the sound quality. The coil main bodies 1 connected together are capable of vibrating a rectangle-shaped diaphragm larger than twice as the length and width of the connected coil main bodies 1. It is understood that the shape of the diaphragm is not limited thereto.

An inner width and an outer width of φ1 and φ2 are only exemplary and not limited thereto.

The hollow portions 4 of the coil main bodies 1 are not only the rectangular shape but also a circular shape, an elliptical shape or a fun shape. The shape of the hollow portions 4 can be varied with a shape of a yoke or an iron core to be inserted therein.

A section of the wire 2 is not only circular but elliptical, square, flat, and rectangular. A material of the wire 2 is not only copper but aluminum or alloys thereof.

The coil main bodies 1 each have a sag portion 5 formed with the lead-in and the lead-out wire portion 3A and 3B with a length 1 (for example 10 mm) between the adjacent main bodies 1. When the sag portions 5 are bonded to a voice coil bobbin (not shown) of the magnetic circuit component, the coil main bodies 1 vibrate in response to extension and contraction movement of the sag portions 5 when the coil main bodies 1 are energized. The connection portions of the coil main bodies 1 prevent the unexpected contact of the coil main bodies 1 to an inner wall of the magnetic gap so as to avoid stretch, compression and ware of the coil main bodies 1 and improve the reliability and quality.

The coil main bodies 1 each have the lead-in wire portion 3A and the lead-out wire portion 3B at the periphery of the end thereof. The lead-out wire portion 3B of one coil main body 1 is communicated to the lead-in wire portion 3A of the adjacent coil main body 1. The lead-in wire portions 3A and the lead-out wire portions 3B each are integral with the associated coil main body 1. The speaker voice coil of the present invention can be manufactured with high production efficiency, resulting in a mass production with low cost.

In the conventional speaker voice coil (JP 2006-246288) a coil main body and a lead wire are connected together with soldering or bonding. The lead wires are soldered one another.

The coil main bodies 1 of the speaker voice coil of the present invention are connected together without soldering to achieve the lightweight and the quick response to the diaphragm. The speaker voice coil has the long life without breaking of the wire. The lightweight of the speaker voice coil keeps level of sound pressure of the speaker, and removes the biased weight and an inhomogeneous amplitude. The speaker voice coil prevents a specified frequency of the diaphragm and provides a correct response of the diaphragm of the voice coil.

The coil main bodies 1, for example, seven coil main bodies, connected together without soldering each are wound with the insulation wire in order to attain high performance and high stability such ad high insulation, low current loss, homogeneous current direction, and small noise.

The arrangement of the lead wires 3A and 3B at the periphery of the coil main bodies 1 removes a restriction of a connection direction to a terminal and provides an ease and reliable connection.

The speaker voice coil of the present invention allows winding of the wire 2 even with a diameter of 0.12 mm, normally 0.05-010 mm. The present invention provides the plurality of the coil main bodies 1 connected together in series with high yield without deformation of the coil main bodies 1 and breaking of the wire 2 during manufacturing.

The speaker voice coil of the first embodiment includes the coil main bodies 1 wound with the copper wire with the diameter of 0.12 mm. The coil main bodies 1 each have two layers of the square shaped coil wound with alpha winding and have the inner width φ1 of 8.5 mm. The coil main bodies 1 have an improved space factor and an effective current flow, resulting in a low noise, high performance, and high reliability speaker voice coil. The speaker voice coil having seven coil main bodies 1 of FIG. 1 has a direct current resistance of 15.6Ω.

The continuously connected lead wire portions 3A and 3B each forms the sag portion 5 having the desired length 1, for example 10 mm, and the coil main bodies 1 vibrate in response to extension and contraction of the sag portions 5 when the coil main bodies are energized. The serial connection of the coil main bodies 1 prevents the lead wire portions 3A and 3B from contacting the magnetic gap of the magnetic circuit and prevents breaking of the electrical wires due to stretch, compression, wear, or mechanical fatigue.

It is appreciated that when the sag portions 5 are bonded to a voice coil bobbin (not shown) of the speaker, movement of the lead wire portions 3A and 3B in the magnetic gap is limited and the breaking of the wires 3A and 3B is prevented, resulting in improvement of reliability and quality.

It is appreciated that the adhesive agent is applied to the side faces 1a beforehand and heated lately or the adhesive agent is applied when heating the side faces 1a.

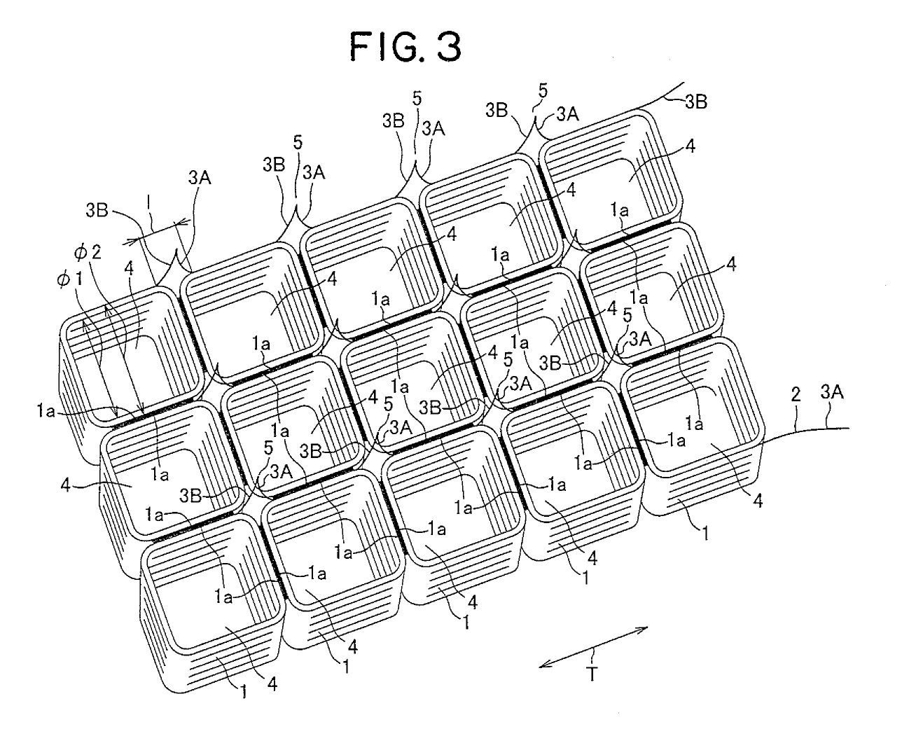

FIG. 3 shows a second embodiment of the speaker voice coil of the present invention.

The coil main bodies 1 are serially arranged in multi lines and columns or a two-dimensional array (3×5 in FIG. 3). The other configuration of the each coil main body 1 is same as that of the first embodiment. The each coil main body 1 has a pair of lead wires at a periphery of an end portion thereof so as to manufacture the coil with high productive efficiency without soldering in contrast to the conventional speaker voice coil. This arrangement provides a robust structure against stretch and compression. The arrangement of the lead wire portions 3A and 3B prevents the connection portions from contacting the inner wall of the magnetic gap and breaking of the wires, and thus provides a long life. The second embodiment of the speaker voice coil has a high efficiency more than the first embodiment and is suitable to vibrate the diaphragm having a large area.

It is appreciated that the number of the coil main bodies 1 and the number of linen and columns are not limited to the exemplary embodiments.

It is appreciated that the coil main bodies 1 each may have the desired number of turns to control current and inductance.

What is claimed is:

1. A speaker voice coil including a plurality of coil main bodies connected to each other in series, the coil main bodies each being formed by winding a wire with a desired diameter and having a lead-in wire portion and a lead-out wire portion at a periphery of one end thereof, the lead-out wire portion of one coil main body being continuously communicated with the lead-in wire portion of an adjacent coil main body.

2. The speaker voice coil as claimed in claim 1l wherein the lead-in wire portion and the lead-out wire portion of the associated coil main body are integral at the periphery of the end of the coil main body and the wire is covered with an insulation.

3. The speaker voice coil as claimed in claim 1, wherein the coil main bodies are disposed in a two-dimensional array.

4. The speaker voice coil as claimed in claim 1, wherein the coil main bodies are formed in a plurality of layers.

5. The speaker voice coil as claimed in claim 1, wherein the coil main bodies each are wound with the wire by a desired number of turns.

6. The speaker voice coil as claimed in claim 1, wherein the coil main bodies each are wound with the wire by the respective numbers of turns.

7. The speaker voice coil as claimed in claim 1, wherein the coil main bodies each are bonded together to each other with an adhesive agent applied between adjacent side faces thereof.

8. The speaker voice coil as claimed in claim 1, wherein the lead-in portion and the lead-out wire portion form a sag portion with a desired length.

9. The speaker voice coil as claimed in claim 8, wherein the sag portions are attached to a voice coil bobbin.

10. The speaker voice coil as claimed in claim 1, wherein the plurality of the coil main bodies are capable of vibrating a diaphragm having a length and a width at least twice as the coil main bodies.

11. The speaker voice coil as claimed in claim 1, wherein the wire has a section of circle, ellipse, square, flat, or rectangle.
